(19) United States
(12) Patent Application Publication
(10) Pub. No.: US 2007/0093236 A1
(43) Pub. Date: Apr. 26, 2007

(54) E-MAIL SENDING SYSTEM, METHOD AND MOBILE DEVICE

(75) Inventors: Wen-Chuan Lian, Shenzhen (CN); Feng Zhou, Shenzhen (CN); Kuan-Hong Hsieh, Shenzhen (CN)

Correspondence Address: NORTH AMERICA INTELLECTUAL PROPERTY CORPORATION, P.O. BOX 506, MERRIFIELD, VA, 22116, US

(73) Assignee: HON HAI PRECISION INDUSTRY CO., LTD., Taipei Hsien (TW)

(21) Appl. No.: 11/309,395

(22) Filed: Aug. 3, 2006

(30) Foreign Application Priority Data
Oct. 20, 2005 (CN) 200510100559.2

(51) Int. Cl. H04Q 7/22

(52) U.S. Cl. 455/412.2; 455/414.1; 709/207

(57) ABSTRACT

A method automatically selecting an appropriate wireless network to send an e-mail is provided. The method includes the steps of: obtaining a priority identifier of an e-mail that is ready to be sent; identifying the obtained priority identifier and generating an associated path selection signal; and sending the e-mail through a corresponding wireless network according to the path selection signal. A related mobile device and system are also provided.

### Technical Field

The present invention relates to e-mail sending systems, methods, and mobile devices, and particularly to a system, method, and mobile device enabling to send e-mails through wireless networks.

### GENERAL BACKGROUND

In recent years, mobile devices with function of sending e-mails are becoming more and more prevalent. Currently, these mobile devices may be configured to communicate via a single wireless network. For example, if the mobile device is configured to communicate via a Wi-Fi network, then the mobile device may connect to and communicate via the Wi-Fi network any time the mobile device is within a Wi-Fi hot spot. If the Wi-Fi network is not available, the mobile device may not be able to communicate with other devices, consequently, e-mails are held in the mobile device until the Wi-Fi network is available even during situations where the e-mails are urgent and need to be sent immediately. In other words, the current mobile devices process normal or urgent e-mails in the same manner, regardless of priority levels of the e-mails.

As a result, the e-mails having higher priority level (namely the urgent e-mails) may be unduly delayed due to the limited area coverage of the Wi-Fi hot spot. Therefore, the mobile device may have to be configured to a wireless network having a relatively wider area coverage instead, for example, a GPRS network. However, the service cost of the GPRS network is relatively higher than the Wi-Fi network. Consequently, the cost of sending the e-mails through the GPRS network is apparently higher than the cost of sending the e-mails through the Wi-Fi network.

What is needed, therefore, is a system, method, and mobile device enabling to send e-mails through a plurality of wireless networks, which can identify the priority levels of the e-mails and select an appropriate wireless network to send the corresponding e-mails, thereby not only ensuring urgent e-mails be sent immediately but also reducing the cost of sending the e-mails.

### SUMMARY

A mobile device enabling to send e-mails through a plurality of wireless networks is provided. The mobile device mainly includes a mail priority identifier obtaining module, a path selecting module, and a mail sending module. The mail priority identifier obtaining module is for obtaining a priority identifier of an e-mail that is ready to be sent. The path selecting module is for identifying the obtained priority identifier and generating an associated path selection signal. The mail sending module is for sending the e-mail through a corresponding wireless network according to the path selection signal.

A method enabling to send e-mails through a plurality of wireless networks is also provided. The method includes the steps of: (a) obtaining a priority identifier of an e-mail that is ready to sent; (b) identifying the obtained priority identifier and generating an associated path selection signal; and (c) sending the e-mail through a corresponding wireless network according to the path selection signal.

Other advantages and novel features will be drawn from the following detailed description with reference to the attached drawing, in which:

### BRIEF DESCRIPTION OF THE DRAWINGS

FIG. 1 is a schematic diagram of a hardware infrastructure of an e-mail sending system in accordance with a preferred embodiment of the present invention;

FIG. 2 is a schematic diagram of main function modules of a mobile device of FIG. 1;

FIG. 3 is a flowchart of a preferred method for automatically selecting a wireless network to send an e-mail by utilizing the system of FIG. 1; and

FIG. 4 is a flowchart further detailing steps involved in the preferred method of FIG. 3.

### DETAILED DESCRIPTION OF THE EMBODIMENT

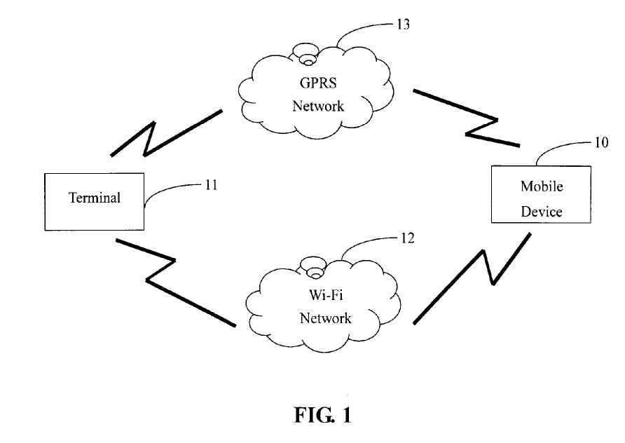

FIG. 1 is a schematic diagram of a hardware infrastructure of an e-mail sending system (hereinafter, “the system”) in accordance with a preferred embodiment of the present invention. The system is capable of automatically selecting an appropriate wireless network to send e-mails. Each e-mail has a priority identifier indicating its priority level. For simplicity, the priority is categorized into three levels: a normal level, an urgent level, and an emergency level. The normal level indicates that the e-mail could be delayed without time limitation. Contrary, the emergency level indicates that the e-mail should be sent out immediately and the urgent level indicates that the e-mail could be delayed for a predetermined time span. In other words, the emergency level has a highest priority level, the urgent level has a midrange priority level, and the normal level has a lowest priority level.

The system mainly includes one or more mobile devices 10, one or more terminals 11, and a plurality of wireless networks. For simplicity, in this embodiment, one mobile device 10, one terminal 11, a first wireless network 12, and a second wireless network 13 are described herein.

Furthermore, the first wireless network 12 has advantages of a relatively high speed and a low cost but a disadvantage of a narrower area coverage compared to the second wireless network 13. In other words, the second wireless network 13 has an advantage of a wider area coverage but disadvantages of a relatively low speed and a high cost compared to the first wireless network 12. Accordingly, the first wireless network 12 takes a Wireless Fidelity (Wi-Fi) network for example, whereas the second wireless network 13 takes a General Packet Radio Service (GPRS) network for example. However, the first wireless network 12 and the second wireless network 13 can be other suitable type networks and not limited by the description herein.

The mobile device 10 is configured with a programmable function of selecting an appropriate wireless network to send the e-mails according to the priority identifiers thereof. Therefore, the mobile device 10 is able to send e-mails to terminal 11 via the appropriate wireless network. The terminal 11 can be a fixed terminal or a movable terminal. Accordingly, the terminal 11 may be a desktop, notebook/laptop, hand-held device, etc.

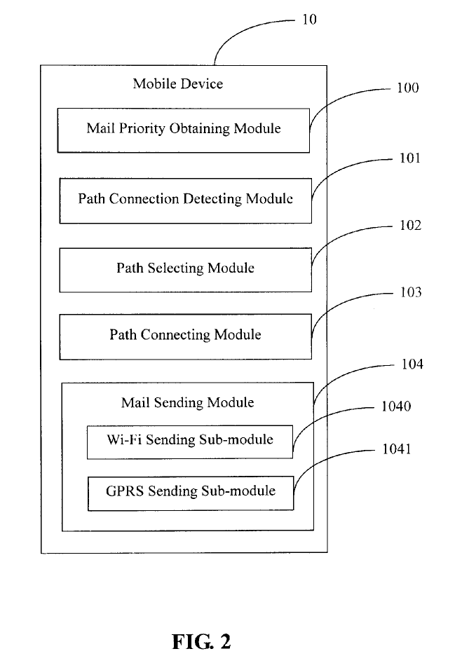

FIG. 2 is a schematic diagram of main function modules of the mobile device 10. The mobile device 10 mainly includes a mail priority obtaining module 100, a path connection detecting module 101, a path selecting module 102, a path connecting module 103, and a mail sending module 104. The mail priority obtaining module 100 is for obtaining the priority identifier of an e-mail that is ready to be sent. The path connection detecting module 101 is for detecting connections between the mobile device 10 and the wireless networks (i.e., Wi-Fi network 12 and GPRS network 13).

The path selecting module 102 is for identifying the obtained priority identifier and for generating an associated path selection signal based on detected results from the path connection detecting module 101. For example, if the priority identifier indicates the normal level, the path selecting module 102 generates a Wi-Fi network selection signal; if the priority identifier indicates the urgent level and the connection between the mobile device 10 and the Wi-Fi network 12 is available within a predetermined time span, the path selecting module 12 generates a Wi-Fi network selection signal; if the priority identifier indicates the urgent level but the connection between the mobile device 10 and the Wi-Fi network 12 remains unavailable within the predetermined time span, the path selecting module 12 generates a GPRS network selection signal; if the priority identifier indicates the emergency level and the connection between the mobile device 10 and the Wi-Fi network 12 is available, the path selecting module 12 generates a Wi-Fi selection signal; if the priority identifier indicates the emergency level and the connection between the mobile device 10 and the Wi-Fi network 12 is unavailable, the path selecting module 12 generates a GPRS network selection signal.

The path connecting module 103 is for establishing the connections between the mobile device 10 and the wireless networks based on the path selection signal if necessary. The mail sending module 104 is for sending the e-mail to the terminal 11 via a corresponding wireless network according to the associated path selection signal. The mail sending module 104 further includes a Wi-Fi sending sub-module 1040 and a GPRS sending sub-module 1041. The Wi-Fi sending sub-module 1040 is initiated to send the e-mail if the path selection signal correspond to the Wi-Fi selection signal. Alternatively, the GPRS sending sub-module 1041 is initiated to send the e-mail if the path selection signal corresponds to the GPRS selection signal.

Therefore, by utilizing the system, a user of the mobile device 10 can send the e-mails via the best cost-efficient routes, thereby not only preventing the e-mails with higher priority levels from unduly delays, but also reducing the cost of network service payment by withholding low priority level emails being sent out via high cost networks.

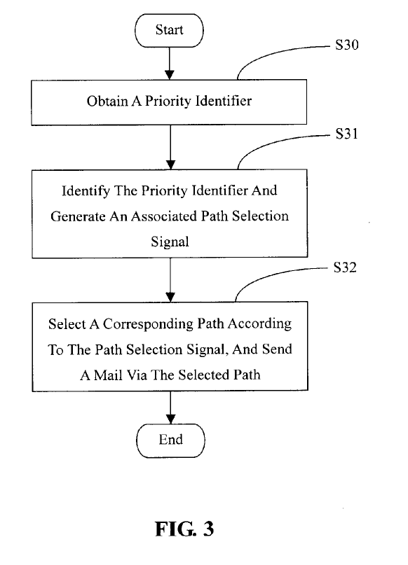

FIG. 3 is a flowchart of a preferred method for automatically selecting the wireless network to send the e-mail by utilizing the system of FIG. 1. In step S30, the mail priority obtaining module 100 obtains the priority identifier of the e-mail that is ready to be sent. In step S31, the path selecting module 102 identifies the priority identifier obtained and generates the associated path selection signal. In step S32, the path connecting module enables the corresponding wireless network based on the associated path selection signal if necessary, and the mail sending module 104 sends the e-mail through the corresponding wireless network according to the associated path selection signal.

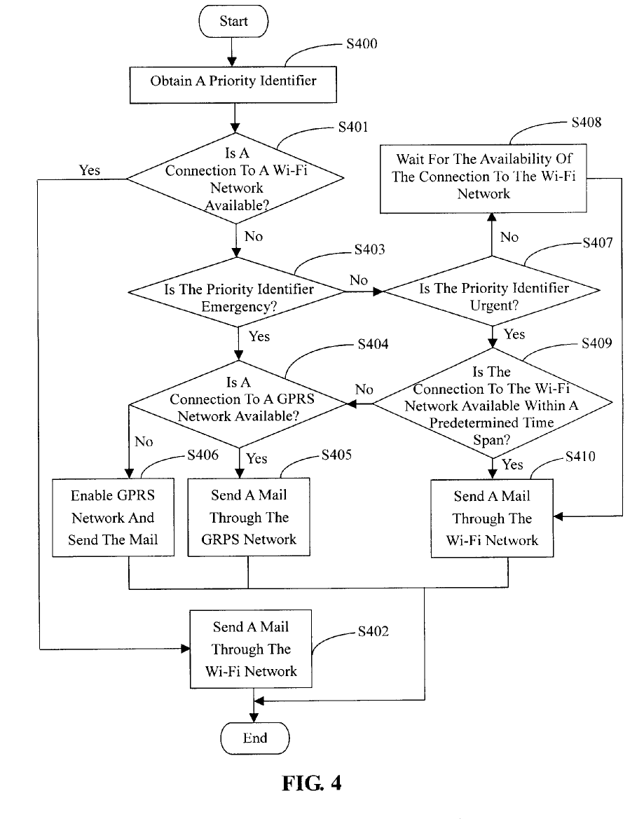

FIG. 4 is a flowchart further detailing steps involved in the preferred method of FIG. 3. In step S400, the mail priority obtaining module 100 obtains the mail priority of the e-mail that is ready to be sent. In step S401, the path connection detecting module 101 detects whether the connection between the mobile device 10 and the Wi-Fi network 12 is available. If the connection to the Wi-Fi network 12 is available, in step S402, the Wi-Fi sending sub-module 1040 initiates to send the mail through the Wi-Fi network 12.

If the connection to the Wi-Fi network 12 is unavailable, in step S403, the path selecting module 102 determines whether the obtained mail priority is the emergency level. If the obtained mail priority is the emergency level, in step S404, the path connection detecting module 101 determines whether the connection between the mobile device and the GPRS network 13 is available. If the connection to the GPRS network 13 is available, in step S405, the GPRS initiates to send the mail through the GPRS network 13. If the connection to the GPRS network 13 is unavailable, in step S406, the path connecting module 103 enables the connection between the mobile device and the GPRS network 13, and the GPRS sending sub-module 1041 initiates to send the mail through the GPRS network 13.

If the obtained mail priority is not the emergency level, in step S407, the path selecting module 102 determines whether the obtained mail priority is the urgent level. If not, in step S408, the Wi-Fi sending sub-module 1040 does not send the mail until the path connection detecting module 101 detects that the connection between the mobile device and the Wi-Fi network 12 is available. If so, in step S409, the path connection detecting module 101 determines whether the connection between the mobile device and the Wi-Fi network 12 is available within a predetermined time span. If the connection to the Wi-Fi network 12 is available in the predetermined time span, in step S410, the Wi-Fi sending sub-module 1040 initiates to send the mail through the Wi-Fi network 12. If the connection to the Wi-Fi network 12 is still unavailable over the predetermined time span, the procedure goes to step S404 to send the mail through the GPRS network 13.

Although the present invention has been specifically described on the basis of a preferred embodiment and preferred method thereof, the invention is not to be construed as being limited thereto. Various changes or modifications may be made to the embodiment and method without departing from the scope and spirit of the invention.

What is claimed is:

1. An e-mail sending system comprising:
a plurality of wireless networks; and
one or more mobile devices, each mobile device comprising:
a mail priority identifier obtaining module for obtaining a priority identifier of an e-mail that is ready to be sent;
a path selecting module for identifying the obtained priority identifier and generating an associated path selection signal; and
a mail sending module for sending the e-mail through a corresponding wireless network according to the path selection signal.

2. The e-mail sending system according to claim 1, wherein the mobile device further comprises a path connection detecting module for detecting available connections between the wireless networks and the mobile devices, and a path connecting module for enabling the connections between the wireless networks and the mobile devices.

3. The e-mail sending system according to claim 2, wherein the priority identifier is selected from the group consisting of a normal level, an urgent level, and an emergency level.

4. The e-mail sending system according to claim 3, wherein the mail sending module sends the e-mail through a first wireless network if the first wireless network is available.

5. The e-mail sending system according to claim 3, wherein the mail sending module sends the e-mail through a second wireless network if the first wireless network is unavailable and the priority identifier is the emergency level.

6. The e-mail sending system according to claim 3, wherein the mail sending module sends the e-mail through the first wireless network if the priority identifier is the urgent level and the first wireless network is available within a predetermined time span.

7. The e-mail sending system according to claim 3, wherein the mail sending mail module sends the e-mail through the second wireless network if the priority identifier is the urgent level and the first wireless network is unavailable within the predetermined time span.

8. A mobile device enabling to send e-mails through a plurality of wireless networks, the mobile device comprising:
a mail priority identifier obtaining module for obtaining a priority identifier of an e-mail that is ready to be sent;
a path selecting module for identifying the obtained priority identifier and generating an associated path selection signal; and
a mail sending module for sending the e-mail through a corresponding wireless network according to the path selection signal.

9. The mobile device according to claim 8, further comprising a path connection detecting module for detecting connections between the wireless networks and the mobile device, and a path connecting module for enabling the connections between the wireless networks and the mobile device.

10. The mobile device according to claim 9, wherein the priority identifier is selected from the group consisting of a normal level, an urgent level, and an emergency level.

11. The mobile device according to claim 10, wherein the mail sending module sends the e-mail through a first wireless network if the first wireless network is available.

12. The mobile device according to claim 10, wherein the mail sending module sends the e-mail through a second wireless network if the first wireless network is unavailable and the priority identifier is the emergency level.

13. The mobile device according to claim 10, wherein the mail sending module sends the e-mail through the first wireless network if the priority identifier is the urgent level and the first wireless network is available within a predetermined time span.

14. The mobile device according to claim 10, wherein the mail sending mail module sends the e-mail through the second wireless network if the priority identifier is the urgent level and the first wireless network is unavailable within the predetermined time span.

15. The mobile device according to claim 14, wherein the first wireless network is a wireless fidelity (Wi-Fi) wireless network, and the second wireless network is a general packet radio service (GPRS) network.

16. A method for sending e-mails through a plurality of wireless networks, the method comprising the steps of:
obtaining a priority identifier of an e-mail that is ready to be sent;
identifying the obtained priority identifier and generating an associated path selection signal; and
sending the e-mail through a corresponding wireless network according to the path selection signal.

17. The method according to claim 16, wherein the priority identifier is selected from the group consisting of a normal level, an urgent level, and an emergency level.

18. The method according to claim 17, wherein the sending step further comprises the steps of:
sending the e-mail through a first wireless network if the first wireless network is available;
sending the e-mail through a second wireless network if the first wireless network is unavailable and the priority identifier is the emergency level;
sending the e-mail through the first wireless network if the priority identifier is the urgent level and the first wireless network is available within a predetermined time span; and
sending the e-mail through the second wireless network if the priority identifier is the urgent level and the first wireless network is unavailable within the predetermined time span.

19. The method according to claim 18, wherein the first wireless network is a wireless fidelity (Wi-Fi) wireless network, and the second wireless network is a general packet radio service (GPRS) network.
